(19) United States
(12) Patent Application Publication
(10) Pub. No.: US 2020/0355026 A1
(43) Pub. Date: Nov. 12, 2020

(54) ROLLER BLIND AND METHOD OF MANUFACTURE

(71) Applicant: SUDU IP PTY LTD as trustee for Sudu IP Unit Trust, Melbourne (AU)

(72) Inventors: Alex Liu, Melbourne (AU); Yi Liu, Melbourne (AU)

(21) Appl. No.: 15/998,915

(22) PCT Filed: Jan. 20, 2017
(86) PCT No.: PCT/AU2017/050038

§ 371 Date: Aug. 16, 2018

(30) Foreign Application Priority Data
Feb. 16, 2016 (AU) 2016900539

(51) Int. Cl. E06B 9/46

(52) U.S. Cl. CPC E06B 9/46; E06B 2009/445

(57) ABSTRACT

The present invention is related to a roller blind comprising: a length of fabric having a first end connected to a roller tube; a bottom rail have a top piece and a bottom piece releasably secure to one another; a connector for attaching to a second end of the length of fabric; wherein the connector comprises a first retention means adapted to releasably secured to the bottom piece of the bottom rail.

### TECHNICAL FIELD

The present invention relates to a roller blind and method of manufacture.

The invention has been developed primarily for use with roller blinds and will be described hereinafter with reference to this application. However, it will be appreciated that the invention is not limited to this particular field of use.

### BACKGROUND

A roller blind is used for providing shading or covering over a window from inside of a building or outside. A roller blind is usually made with a roller tube, a blind fabric and a bottom rail along with bracketing, a drive, an end axle and bottom rail end caps.

Roller tubes are commonly made of aluminium or mild steel through extrusion or rolling milling forming. Rather than tubing, the roller can also be solid such as a wooden rod as in the early days. Roller blind fabrics are can be made of different kind of materials.

Different roller blind fabrics provide different levels of light filtering up to 100% light blocking opacity, otherwise known as block-out fabric.

The bottom rail provides some weight to the bottom of the roller blind so as to keep the blind straight and flat. It is commonly made of aluminium or plastic.

The issues in current roller blind manufacturing include that roller blind fabrics are fixed to the roller tube by either one of two methods. The first method involves using double-sided sticky tape to attach the fabric directly to the tube. The second method is to have a spline attached to one end of the roller fabric which is, then slid into a channel on the roller tube. Similarly, the bottom rail is usually fixed to the other end of the fabric by using a spline to slide into the slot or channel on the bottom rail.

When the roller blind is made, it is rolled tightly and wrapped with some scratch scrap fabric. Tapes are used to hold the roll in place before it is put into a plastic sleeve in order to protect it from dust/dirt during handling and shipping.

As roller blinds are mostly long elongated items, all actions involving the sticking or sliding of a soft fabric edge into a narrow channel, tying the roller blind to prevent it unrolling, and inserting it into a soft plastic sleeve are all difficult tasks for any kind of automation. As a result, current production processes are mostly carried out manually, which are very inefficient, leading to labour costs accounting for a significant part of the total costs for a roller blind. Further, there is a large spoilage factor by these methods.

The present invention seeks to provide a roller blind and method of manufacture, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY

It is, therefore, an object of the present invention is to provide a roller blind for that is cost-effective and economical to manufacture, market and sell.

Other objects and advantages will become apparent when taken into consideration with the following specification and drawings.

It is also an object of the present invention to overcome or ameliorate at least one of the disadvantages of the prior art, or to provide a useful alternative.

According to a first aspect of the present invention, there is provided a roller blind comprising:

a length of fabric having a first end connected to a roller tube;

a bottom rail have a top piece and a second piece releasably secure to one another;

a connector for attaching to a second end of the length of fabric;

wherein the connector comprises a first retention means adapted to releasably secured to the bottom piece of the bottom rail.

Preferably, the retention means of the connector is adapted to frictionally clamp on the bottom piece.

Preferably, the first retention means comprises one or more retention teeth to clamp on one or more retaining structure of the bottom piece.

Preferably, the connector comprises a second retention means adapted to releasably secure to the top piece of the bottom rail.

Preferably, the second retention structure comprises one or more hook attaching to another retaining structure of the top piece of the bottom rail.

Preferably, the bottom piece of the bottom rail comprising a retention means for releasably attaching to the top piece of the bottom rail.

Preferably, the retention means comprising a hook for attaching to another hook structure on the top piece of the bottom rail.

Preferably, the second end of the length of fabric is attached to the connector by mating the length of fabric with the connector.

Preferably, the second end of the length of fabric is mated to the connector through a diffusion bond.

Preferably, the connector is made of a piece of plastic material which is adapted to form a diffusion bond with the fabric.

Preferably, the roller tube comprising a retention means for embedding a strip attaching to the one end of the length of fabric.

Preferably, the retention structure comprising a groove have one or more teeth disposed on a wall thereof for frictionally clamping the strip therein.

Preferably, the strip is attached to the first end of the fabric by mating the strip and the fabric through a diffusion bond.

Preferably, the strip is made of a plastic adapted to form a diffusion bond with the first end of the length of fabric.

In another aspect of the present invention, there is provided a method of manufacturing a roller blind comprising the step of:

providing a length of fabric adapted for using as a blind;

providing a roller tube having a retention means;

embedding a strip into the retention means; and

mating a first end of the length of fabric over the tube with the strip.

Preferably, the strip is mated to the first end of the fabric with a diffusion bond.

Preferably, the diffusion bond is generated by ultrasonic welding the first end of the fabric and the strip.

Preferably, the strip is made of a piece of plastic material adapted to form a diffusion bond with the first end of the length of fabric.

Preferably, the method further comprises the step of:

providing a bottom piece of a bottom rail;

attaching a connector to the bottom piece by clamping a retention means of the connector to the bottom rail; and

mating a second end of the length of fabric to the connector.

Preferably, the second end of the length of fabric is mated to the connector with a diffusion bond.

Preferably, the diffusion bond is generated by ultrasonic welding.

Preferably, the method further comprises the step of clamping a top piece of the bottom rail to the connector and the bottom piece such that the top piece of the bottom rail is releasably secured to the connector and the top piece.

Preferably, the connector is made of a piece of plastic material adapted to form a diffusion bond with the first end of the length of fabric.

It can be seen that the invention of a roller blind and method of manufacture provides the benefit of allowing automatic manufacturing which previously was not possible.

Other aspects of the invention are also disclosed.

### BRIEF DESCRIPTION OF THE FIGURES

Notwithstanding any other forms which may fall within the scope of the present invention, a preferred embodiment/preferred embodiments of the invention will now be described, by way of example only, with reference to the accompanying drawings in which:

FIG. 1 is a diagrammatic general form of a roller blind in accordance with a preferred embodiment of the present invention; and

FIGS. 2 and 3 are cross-sectional views showing steps in forming the connection of fabric to the top roller tube that is driven by a manually operated clutch or the motor of the motorised roller blinds in accordance with a preferred embodiment of the present invention;

FIGS. 4 and 5 are cross-sectional views showing steps in forming the connection of fabric to the one form of the bottom rail that is connected to the other end of the fabric of the roller blinds in accordance with a preferred embodiment of the present invention;

FIG. 6 is a cross-sectional view of another embodiment of a bottom rail that is connected to the other end of the fabric of the roller blinds in accordance with a preferred embodiment of the present invention;

FIG. 7 is a cross-sectional view of yet another embodiment of a bottom rail that is connected to the other end of the fabric of the roller blinds in accordance with a preferred embodiment of the present invention;

FIG. 8 is a cross-sectional view of a film wrapped fully formed roller blind; and

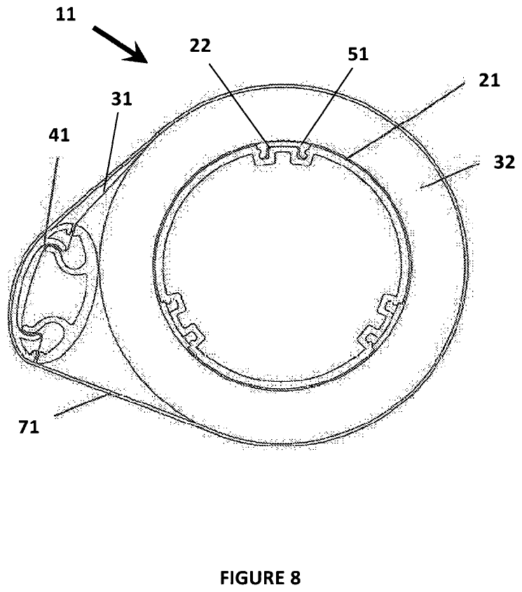

FIG. 9 is a diagrammatic flow diagram of the steps useable in automatically forming a roller blind in accordance with a preferred embodiment of the present invention.

FIG. 10 is a cross-sectional view of another embodiment of a bottom rail that is connected to the other end of the fabric of the roller blinds in accordance with a preferred embodiment of the present invention;

### DESCRIPTION OF THE INVENTION

It should be noted in the following description that like or the same reference numerals in different embodiments denote the same or similar features.

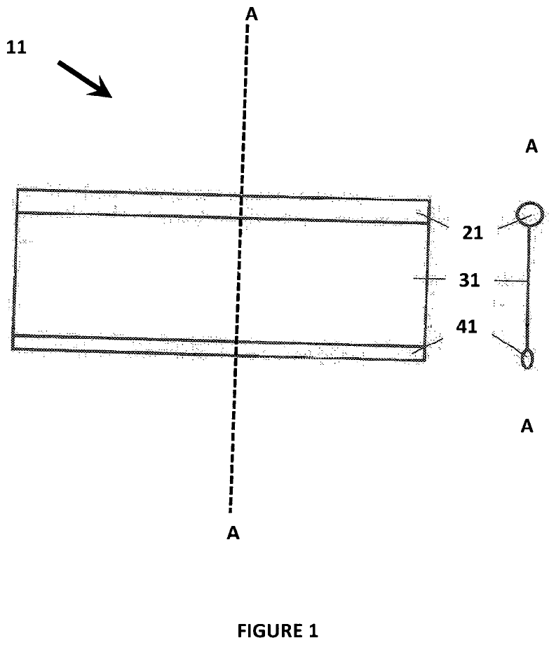

Referring to the drawings there is shown roller blinds 11. As shown in FIG. 1 and the cross section detail through A-A this is generally formed of an elongated roller tube 21, and a length of fabric 31 extending therefrom and to a bottom rail 41.

The fabric is able to overlay the elongated roller tube 21 and be connected in the overlay position along its length to the elongated roller tube and rolled around the elongated roller tube. The fabric 31 is able to connect to the bottom rail 41 which can be formed of two opposed matching elongated rail parts with the other end of fabric able to overlay at least one of the two opposed matching elongated rail parts and be connected in the overlay position along its length to the bottom rail so that the roller blind is able to be constructed in a substantially localised position by automatic means.

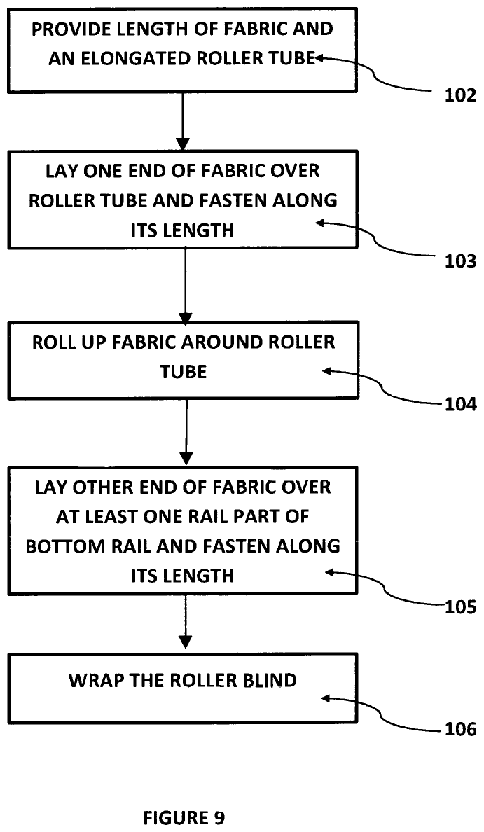

With reference to FIG. 9 there is shown a process of automatically forming a roller blind 11 in accordance with a form of the invention. That method includes a series of steps so that automation is achievable.

In step 102 there is the providing of a length of fabric 31 to form the blind 11 and further provide and coalign an elongated roller tube 21 having at least one channel 22, 23.

In step 103 there is the step of laying a first end of the length of fabric 31 over the elongated roller tube 21 and fixing the fabric 31 to the roller tube in location of the channel 22.

In step 104 the fabric 31 can be wound around the roller tube 21 to form a spiral roll 32 of fabric with a loose end.

In step 105 the loose end of fabric 31 is laid over at least one rail part of bottom rail 41

The roller tube 21 is made of aluminium and with special channels 22, 23 so that a plastic strip 51 can be embedded into it. In one embodiment, the plastic strip 51 is embedded into the channel 22, 23 through beading insertion such that the plastic strip 51 is frictionally clamped into the channel.

Such plastic strip is made of a material that, with the fabric, forms matching parts for ultrasonic welding by ultrasonic welder 52. By ultrasonic welding, the blind fabric 31 is welded onto the plastic strip 51 that is firmly embedded in the channel 22 of the roller tube 21 to form the link between the blind fabric 31 and the roller tube 21.

In another for III the plastic strip 51 can be an adhesive strip and attached to fabric 31 by heat from a heater 52.

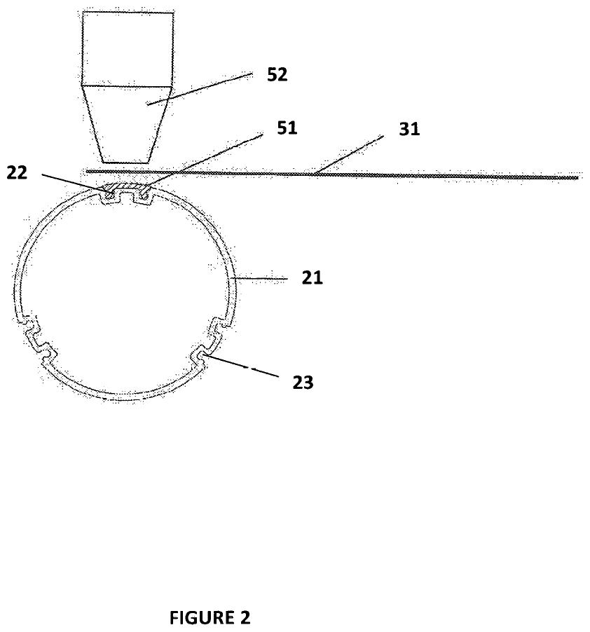

In one embodiment, the channel 21, 22 provides securing means such as grooves to secure the plastic strip 51 in the channel 21, 22 direct pulling while allowing the removal of the plastic strip through sideway sliding. In one embodiment, the walls of the groove or the plastic strip 51 comprise one or more complimentary retention structure for frictionally clamping one with another. In one embodiment, the retention structure is in the form of one or more retention teeth as shown in 24 of FIGS. 2 to 3.

In this way, the plastic strip 51 can first be embedded into the roller tube 21 by pressing or clamping action. The pressing or clamping action can be carried out using a pressing or clamping machine and hence the process can be automated without manual intervention.

Ultrasonic welding is the process of creating a diffusion bond between two compatible plastic materials. Welding offers superior strength, and often drastically reduced cycle times, to mechanical joining (snap fits, screws) and chemical bonding (adhesives).

Then the blind fabric 31 can be weld onto the plastic strip 51 of the roller using high-frequency ultrasonic acoustic vibrations which is locally applied to fabric on top of plastic strip (‘ultrasonic welding_).

Thereby, the blind fabric 31 is permanently welded to plastic strip 51 which is removably secured to roller tuber 21.

However it can be seen that this form of construction allows automation by allowing a continuously consistent cross-sectional tube 21 to be formed and cut substantially to the width of the fabric 31 which is simply laid over the channel 22 having the attaching strip 51. The operation of joining is achieved by an overhanging machine 52.

The bottom rail 41 is formed by two pieces 42 and 43. These two pieces 42, 43 area mating pair that lock together and form a single unit 41. By having a roller blind fabric 31 placed between the two pieces 42, 43, then connecting together the two pieces of bottom rail, the fabric is held firmly therebetween.

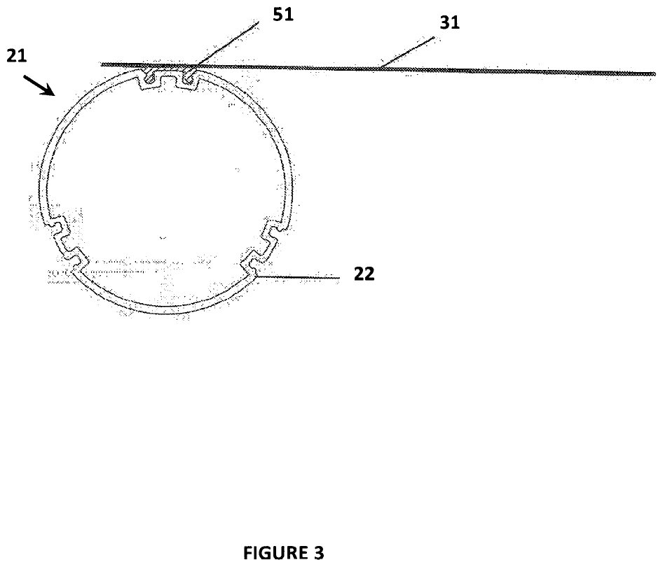

Referring to FIGS. 4 and 5, the bottom rail 41 is designed in a way so that one part grabs the other when connecting them together.

The engagement of the two pieces 42, 43 of the bottom rail 41 can be released by resilient spring force as shown by above figures in which the internal fingers 63, 64 extending from opposing shell parts 61, 62 of the bottom rail 41 are made of a plastic material and the engagement is by the resilient elasticity of these parts.

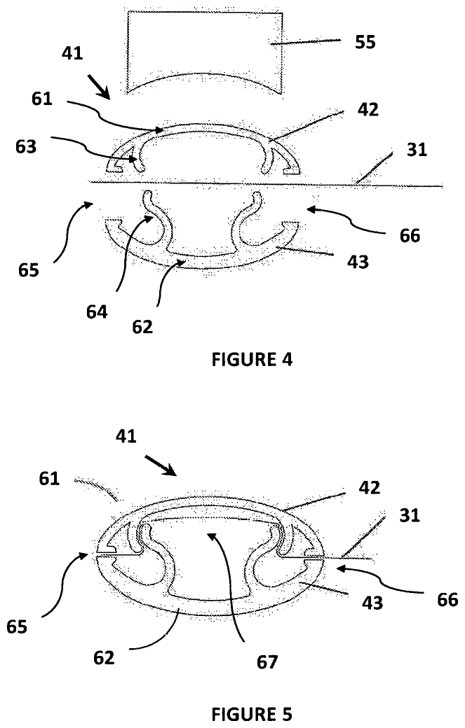

FIG. 6 shows another way to achieve the engagement of the two pieces. Both the top and bottom pieces 12, 13 having shell components 61, 62 with inward fingers 63, 64 are made of aluminium (rigid material), the two little pieces in the centre are made of plastic (non-rigid material). clamping within the two mating pieces The combination of these parts makes a circuitous path 67 between side opening 65 and opening on other side 66 so that the fabric extending through these openings and around the circuitous path are held in frictional contact within the bottom rail 41.

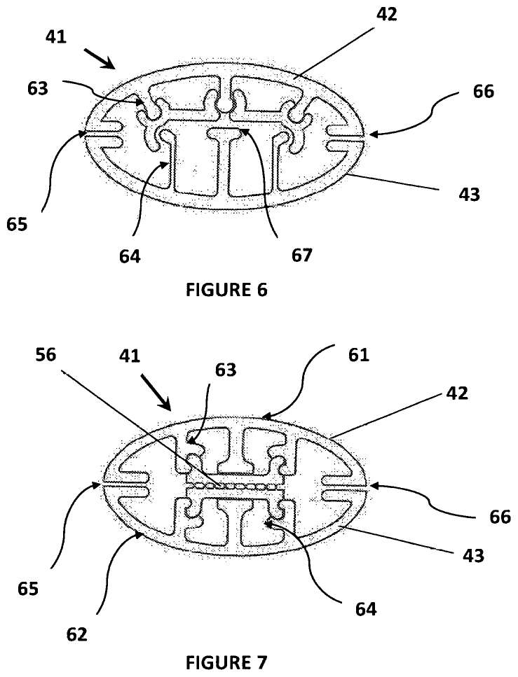

FIG. 7 shows a design to allow for ultrasonic welding to put the parts together. In FIG. 7, the outer two pieces are made of aluminium, and the little two plastic connector 56 at the centre that are ultrasonically weldable. This provides a solid hold of the fabric extending through the bottom rail between the opposing openings 65, 66.

It can be seen that the connection steps of the other end of the fabric 31 to the bottom rail 41 can be undertaken automatically as the steps of construction have been simplified to laying the end over the part 43 of the bottom rail and mating the other part 42 to clamp the fabric therebetween in a single action over the entire length of the bottom rail.

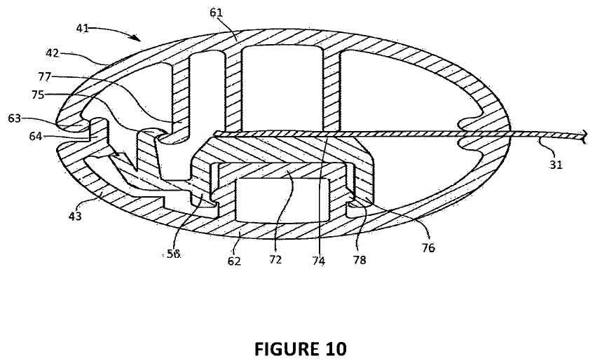

Reference is now made to FIG. 10. FIG. 10 shows another embodiment of the bottom rail 41, which also comprises a top piece 42 and bottom piece 43. A piece of plastic connector 56 for attaching the blind fabric 31 is adapted to releasably securing to the bottom piece 43.

The plastic connector 56 and the bottom piece 43 comprises one or more complimentary retention structure for frictionally clamping one with another. In one embodiment as shown in FIG. 10, the retention structure comprising a support 72 at the bottom piece 43, one or more holders 76 of the plastic connector 56 for engaging with the support. The support 72 and the holders 76 comprises one or more retention teeth 78.

In one embodiment as shown in FIG. 10, the bottom piece 43 further comprises a second inward finger 64 for engaging with a first inward finger 63 of the top piece. The plastic connector 56 also comprises a first retention hook 75 for engaging with a second retention hook 77 of the top piece 42.

The plastic connector 56 provides a platform 74 for supporting a blind fabric 31 such that the blind fabric can be attached to the plastic with a diffusion bond through ultrasonic welding by an ultrasonic welder 52. Hence, the plastic connector 56 is made of a piece of plastic material which is adapted to form a diffusion bond with the blind fabric 31.

The top piece 42 is secured to the piece of plastic connector 56 and the bottom piece 43 against direct pulling. However, the top piece 42 is adapted to be removed from the bottom rail 41 by sliding sideway. Similarly, the piece of plastic connector 56 is also adapted to be removed from the bottom piece 43 by sideway sliding action.

In the manufacturing process of the embodiment shown in FIG. 10, the piece of plastic connector 56 is secured to the bottom piece 43 by pressing or clamping action using a pressing or clamping machine 55 or similar equipment. The blind fabric 31 is then welded to the piece of plastic connector 56 using an ultrasonic welding machine 52. Then the top piece 42 is secured to the piece of plastic connector 56 and the bottom piece 43 with the pressing machine 55. All these steps can be achieve automatically without manual intervention. The top piece 42, bottom pieces 43, and the piece of plastic connector 56 are all releasable with sliding motion, and hence they can be easily be replaced.

The packaging of a finished roller blind 11 is undertaken by using wrapping film 71 leaving the end of roller open at the sides for accessing roller blinds drives. These drives can be a chain winder as for manually operated system or an internally mountable motor or end connecting motor as for motorised systems. This wrapping packaging protects the roller blind in production and on-site installation.

It can be seen that all of the above innovations to the roller blind products greatly improve the ability to have the overall automation process of the invention. These innovations are not obvious to anyone who has the intent to have automation in roller blind manufacturing as there has been a long felt want but no progression to any effective automatic manufacture. So from an automation production point of view, the above inventions are very advanced and important.

### Interpretation

### Embodiments

Reference throughout this specification to ‘one embodiment_ or ‘an embodiment_ means that a particular feature, structure or characteristic described in connection with the embodiment is included in at least one embodiment of the present invention. Thus, appearances of the phrases ‘in one embodiment_ or ‘in an embodiment_ in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herd n include some but not other features included in other embodiments, combinations of features of different embodiments are meant to be within the scope of the invention, and form different embodiments, as would be understood by those in the art. For example, in the following claims, any of the claimed embodiments can be used in any combination.

Different Instances of Objects:

As used herein, unless otherwise specified the use of the ordinal adjectives ‘first_, ‘second_, ‘third_, etc., to describe a common object, merely indicate that different instances of like objects are being referred to, and are not intended to imply that the objects so described must be in a given sequence, either temporally, spatially, in ranking, or in any other manner.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Comprising and Including

In the claims which follow and in the preceding description of the invention, except where the context requires otherwise due to express language or necessary implication, the word ‘comprise_ or variations such as ‘comprises_ or ‘comprising_ are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the roller blind and roller blind manufacturing industrial.

1. A roller blind comprising:
a length of fabric having a first end connected to a roller tube;
a bottom rail have a top piece and a bottom piece releasably secure to one another;
a connector for attaching to a second end of the length of fabric;
wherein the connector comprises a first retention means adapted to releasably secured to the bottom piece of the bottom rail.

2. A roller blind according to claim 1, wherein the retention means of the connector is adapted to frictionally clamp on the bottom piece.

3. A roller blind according to claim 1 or claim 2, wherein the first retention means comprises one or more retention teeth to clamp on one or more retaining structure of the bottom piece.

4. A roller blind according to claim 1 or claim 2, wherein the Connector comprises a second retention means adapted to releasably secure to the top piece of the bottom rail.

5. A roller blind according to claim 3, wherein the second retention structure comprises one or more hook attaching to another retaining structure of the top piece of the bottom rail.

6. A roller blind according to any one of claims 1 to 4, wherein the bottom piece of the bottom rail comprising a retention means for releasably attaching to the top piece of the bottom rail.

7. A roller blind according to claim 5, wherein the retention means comprising a hook for attaching to another hook structure on the top piece of the bottom rail.

8. A roller blind according to any one of claims 1 to 7, wherein the second end of the length of fabric is attached to the connector by mating the length of fabric with the connector.

9. A roller blind according to claim 8 wherein the second end of the length of fabric is mated to the connector through a diffusion bond.

10. A roller blind according to claim 9, wherein the connector is made of a piece of plastic material which is adapted to form a diffusion bond with the fabric.

11. A roller blind according to any one of claims 1 to 10, wherein the roller tube comprising a retention means for embedding a strip attaching to the one end of the length of fabric.

12. A roller blind according to claim 11, wherein the retention structure comprising a groove have one or more teeth disposed on a wall thereof for frictionally clamping the strip therein.

13. A roller blind according to claim 12, wherein the strip is attached to the first end of the fabric by mating the strip and the fabric through a diffusion bond.

14. A roller blind according to any one of claims 11 to 13, wherein the strip is made of a plastic adapted to form a diffusion bond with the first end of the length of fabric.

15. A method of manufacturing a roller blind comprising the step of:
providing a length of fabric adapted for using as a blind;
providing a roller tube having a retention means;
embedding a strip into the retention means; and
mating a first end of the length of fabric over the tube with the strip.

16. A method according to claim 15, wherein the strip is mated to the first end of the fabric with a diffusion bond.

17. A method according to claim 16 wherein the diffusion bond is generated by ultrasonic welding the first end of the fabric and the strip.

18. A method according to any one of claims 15 to 17, wherein the strip is made of a piece of plastic material adapted to form a diffusion bond with the first end of the length of fabric.

19. A method according to any one of claims 15 to 18 further comprising the step of:
providing a bottom piece of a bottom rail;
attaching a connector to the bottom piece by clamping a retention means of the connector to the bottom rail; and
mating a second end of the length of fabric to the connector.

20. A method of claim 19, wherein the second end of the length of fabric is mated to the connector with a diffusion bond.

21. A method of claim 20, wherein the diffusion bond is generated by ultrasonic welding.

22. A method of any one of claims 19 to 21, further comprising the step of clamping a top piece of the bottom rail to the connector and the bottom piece such that the top piece of the bottom rail is releasably secured to the connector and the top piece.

23. A method according to any one of claims 19 to 22, wherein the connector is made of a piece of plastic material adapted to form a diffusion bond with the first end of the length of fabric.
